(19) United States
(12) Patent Application Publication
(10) Pub. No.: US 2013/0170736 A1
(43) Pub. Date: Jul. 4, 2013

(54) DISPARITY ESTIMATION DEPTH GENERATION METHOD

(71) Applicants: Jiun-In GUO, Minsyong Township (TW); Kuan-Hung CHEN, Dalin Township (TW); Cheng-Hao CHEN, Tainan City (TW)

(72) Inventors: Jiun-In GUO, Minsyong Township (TW); Kuan-Hung CHEN, Dalin Township (TW); Cheng-Hao CHEN, Tainan City (TW)

(21) Appl. No.: 13/491,374

(22) Filed: Jun. 7, 2012

(30) Foreign Application Priority Data
Dec. 30, 2011 (TW) 100149936

(51) Int. Cl. G06K 9/48; G06K 9/36

(52) U.S. Cl. 382/154

(57) ABSTRACT

A disparity estimation depth generation method, wherein after inputting an original left map and an original right map in a stereo color image, compute depth of said original left and right maps, comprising following steps: perform filtering of said original left and right maps, to generate a left map and a right map; perform edge detection of an object in said left and right maps, to determine size of at least a matching block in said left and said right maps, based on information of two edges detected in an edge-adaptive approach; perform computation of matching cost, to generate respectively a preliminary depth map, and perform cross-check to find out at least an unreliable depth region from said preliminary depth map to perform refinement; and refine errors in said unreliable depth region, to obtain correct depth of said left and said right maps.

### BACKGROUND OF THE INVENTION

1. Field of the Invention

The present invention relates to a depth information generation method in a stereo display system, and in particular to a depth information generation method capable of generating depth information through disparity estimation.

2. The Prior Arts

Advanced Stereo Display Technology relies on depth map information to produce stereo effect. In viewing 3-D images, multi vision-angle images must be merged, so that the viewer may view images of different vision-angles in producing a sense of stereo of real life. Therefore, in taking pictures, a plurality of cameras have to be used to achieve multi vision-angle broadcasting. However, the volume required for storing multi vision-angle display is exceedingly large, therefore, vision-angle merging technology must be used to reduce volume of data required to be stored. In addition, the vision-angle merging technology is realized through matching depth information of the respective vision-angles. As such, how to produce correct and accurate depth map is a critical technology in stereo display applications.

Presently, most of the depth generation technologies are capable of producing a single image having depth. Though in order to promote 3-D display, a 2-D to 3-D depth generation system is required, yet that is only a transition technology for promoting and popularizing 3-D display system. Since the multi vision-angle 3-D image generation technology is the mainstay for the development of 3-D display in the future, therefore the development of multi vision-angle image depth generation technology is an urgent task in this field. And that can be applied in a pseudo vision-angle generation technology for merging vision angles, so that not only the hardware cost (for example, camera used for taking pictures) and data storage space can be reduced, but the viewer may also experience the stereo sense of real life.

Refer to FIG. 1 for a sorting and estimation technology for a high density 2-D stereo (corresponding) algorithm. As shown in FIG. 1, the left map shows the matching block, that is used to find a best matching block 10 in the right map within a fixed matching range (also referred to as Disparity Range). In this matching process, upon computing the matching cost, select the best matching block based on the minimum matching cost. However, in applying this technology, it could have inaccurate matching problem in the following regions:

1. Repetitive region/Texture region: for example, for window curtain, wall, sky, etc, it could search and obtain a plurality of similar corresponding points, therefore, it may compute similar matching values, so it is rather difficult to determine the accurate depth values.

2. Occlusion region: that means it can take pictures of one side of an image, but it can not obtain pictures of the other side of image, thus it can not find the corresponding point.

3. Depth non-continuous region: for example, edge of an object, in case that fixed block size is used to match, it is difficult to get accurate depth map near the edge.

The matching cost computation method used frequently are: Sum of Absolute Difference (SAD), Sum of Square Difference (SSD), Mean of Absolute Difference (MAD), Mean of Absolute Difference (MAD), and Hamming Distance, etc., and they all have the problem of inaccurate matching mentioned above, that can be expressed in the following expressions (1) to (4). Wherein, L and R indicate left map and right map, W indicates a matching block, ∥W∥ indicates size of block, d is the disparity range, with its range from 0 to dr−1. Wherein, the Hamming Distance is computed from the information of the original left and right maps after going through the Census Transform, other parameters can be computed directly from the original left and right maps. The Census Transform is as shown in FIG. 2, wherein, a 3*3 matrix is taken as an example for explanation. Wherein, the pixel value of each position element of the matrix is compared with that of the element of the central position, and in case the former is greater than the latter, then that position is set as logical 1, otherwise, that position is set as logical 0. The left and right maps obtained through Census Transform are indicated as L′ and R′, then the Hemming Distance is computed by means of equation (4) as the matching cost.

$$\begin{matrix}{Cost}_{SAD} = {\sum }_{( i , j ) ∈ W} \vert L ( i , j ) - R ( i - d , j ) \vert , d ∈ [ 0 , dr - 1 ] & ( 1 ) \\ {Cost}_{SSD} = {\sum }_{( i , j ) ∈ W} {( L ( i , j ) - R ( i - d , j ) )}^{2} , d ∈ [ 0 , dr - 1 ] & ( 2 ) \\ {Cost}_{MAD} = \frac{1}{‖ W ‖} {\sum }_{( i , j ) ∈ W} \vert L ( i , j ) - R ( i - d , j ) \vert , d ∈ [ 0 , dr - 1 ] & ( 3 ) \\ {Cost}_{Ham} = {\sum }_{( i , j ) ∈ W} {L}^{′} ( i , j ) XOR {R}^{′} ( i - d , j ) , d ∈ [ 0 , dr - 1 ] & ( 4 )\end{matrix}$$

In addition, in a treatise “Occlusion handling based on support and decision” of Proc. Of IEEE ICIP, pp. 1777-1780, September 2009, a support-and-decision process is used to repair image depth, with color difference serving as weight, to compute the support function of the Occlusion Region. The higher function value thus obtained is used to compensate for the background depth, while the lower function value is to compensate for the foreground depth. However, this algorithm is capable of repair actions only through repeated computations, thus increasing the computation time required.

Therefore, presently, the design and performance of the stereo display system depth generation method is not quite satisfactory, and it has much room for improvements.

### SUMMARY OF THE INVENTION

In view of the problems and shortcomings of the prior art, A major objective of the present invention is to provide a disparity estimation depth generation method, which utilizes edge-adaptive block matching to find the correct depth value based on characteristic of object shape, to enhance the accuracy of block matching.

Another objective of the present invention is to provide a disparity estimation depth generation method, which utilizes the unreliable depth region depth refinement algorithm, to cross check the errors of the left and right depth maps, and reduce bits of color information of the original left and right maps, as such defining ranges of the repaired depth map, to eliminate large amount of errors in the occlusion region.

A further objective of the present invention is to provide a disparity estimation depth generation method, which utilizes group-based disparity estimation, and left and right depth replacement algorithms to determine swiftly disparity values of blocks, so as to raise computation speed.

In order to achieve the above-mentioned objective, the present invention provide a disparity estimation depth generation method. Wherein, on receiving the input original left and right maps in the stereo color image, perform filtering of the original left and right maps, to generate the left and right maps respectively. Next, perform edge detection of objects in the left and right maps, to detect information of the two edges based on an edge-adaptive algorithm, in determining size of at least a matching block in the left and right maps. Then, compute the matching cost, to produce the preliminary depth maps of the left and right maps, and perform cross-check, to find the unreliable depth regions with un-conforming depth from the preliminary depth maps. Finally, repair errors in the unreliable depth regions, to obtain correct depth of the left and right maps.

Further scope of the applicability of the present invention will become apparent from the detailed description given hereinafter. However, it should be understood that the detailed description and specific examples, while indicating preferred embodiments of the present invention, are given by way of illustration only, since various changes and modifications within the spirit and scope of the present invention will become apparent to those skilled in the art from this detailed description.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The related drawings in connection with the detailed description of the present invention to be made later are described briefly as follows, in which:

FIG. 1 is a schematic diagram of a matching block search method according to the prior art;

FIG. 2 is a schematic diagram of Census Transform according to the present invention;

FIG. 3 is a flowchart of the steps of a disparity estimation depth generation method according to the present invention;

FIG. 4 is a schematic diagram of determining size of a dynamic matching block according to the present invention;

FIG. 5 is a schematic diagram of determining edge-adaptive block extension length according to the present invention;

FIG. 6 is schematic diagram of depth refinement, dark region in the left map indicates unreliable depth regions in the depth map, and the right map is a color map after reduction of 4 bits;

FIG. 7 shows the program codes of depth refinement algorithm according to the present invention;

FIG. 8 is a flowchart of the steps of group-based depth generation technology according to the present invention;

FIG. 9 is a schematic diagram of the size of an edge-adaptive block according to the present invention; and

FIG. 10 is a flowchart of steps of left and right depth replacement algorithm according to the present invention.

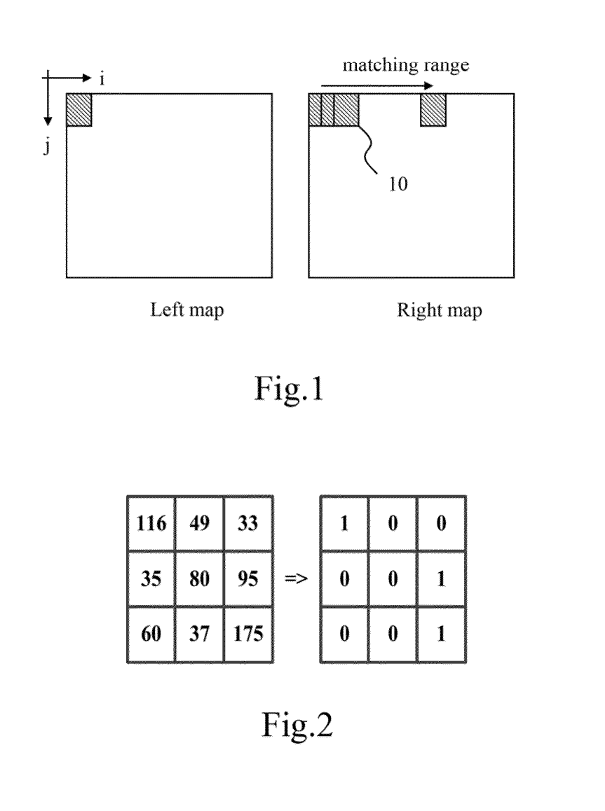

### DETAILED DESCRIPTION OF THE PREFERRED EMBODIMENT

The purpose, construction, features, functions and advantages of the present invention can be appreciated and understood more thoroughly through the following detailed description with reference to the attached drawings. And, in the following, various embodiments are described in explaining the technical characteristics of the present invention.

The present invention provides a disparity estimation depth generation method, to adopt edge-adaptive block matching algorithm to enhance accuracy of block matching, to utilize unreliable depth region depth refinement algorithm to correct a large amount of errors in the occlusion region, and also propose a group-based disparity estimation algorithm and a left and right depth replacement algorithm to increase the computation speed.

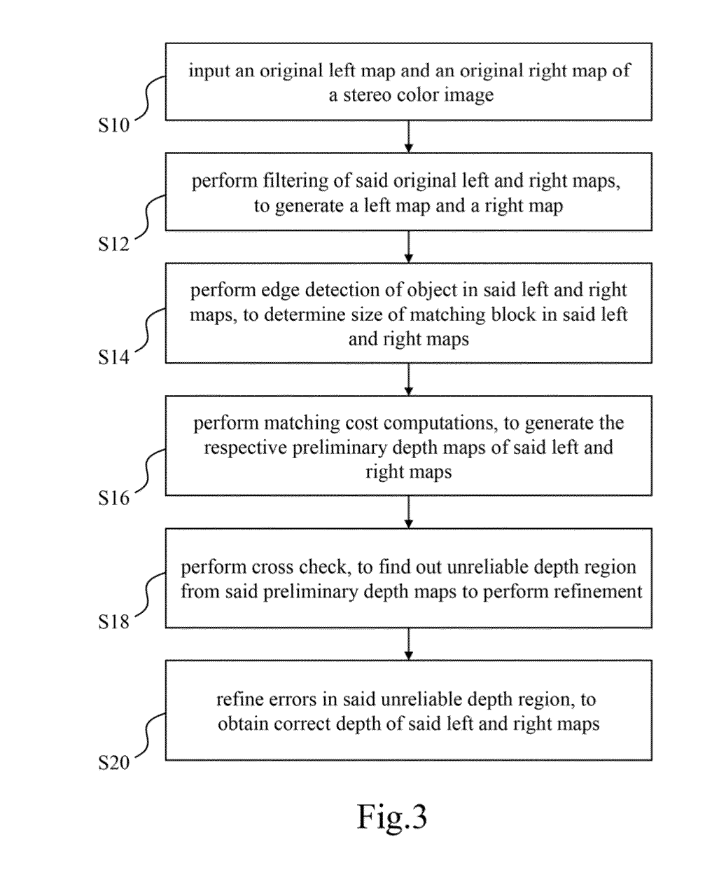

Refer to FIG. 3 for a flowchart of the steps of a disparity estimation depth generation method according to the present invention. As shown in FIG. 3, firstly, in step S10, input an original left map and an original right map of a stereo color image. Next, as shown in step S12, perform filtering of the original left map and the original right map, through utilizing low-pass filter, such as Mean Value Filter, Middle Value Filter, Gauss Filter, etc. to filter out unclear texture in the original map, and produce a left map and a right map, so as to reduce the edge map noise generated in the subsequent edge detections.

Then, at step S14, perform edge detection of an object in the left and right maps, through utilizing Sobel, Canny, Laplacian, Robert or Prewitt edge detection algorithm. Furthermore, the contrast of the original left and right maps can be enhanced, to increase the edge detection effect. The contrast enhancement algorithm can be classified into linear enhancement and Histogram Equalization. Herein, the linear enhancement is taken as an example for explanation. As shown in the following equation (5), wherein, a is an enhancement value of enhanced image, b is a bias value of enhanced image. As such, through adjusting a and b, the original maps I(i, j) may produce image of better contrast, and I′ (i, j) represents enhanced image.

I′(i,j)=a*I(i,j)+b (5)

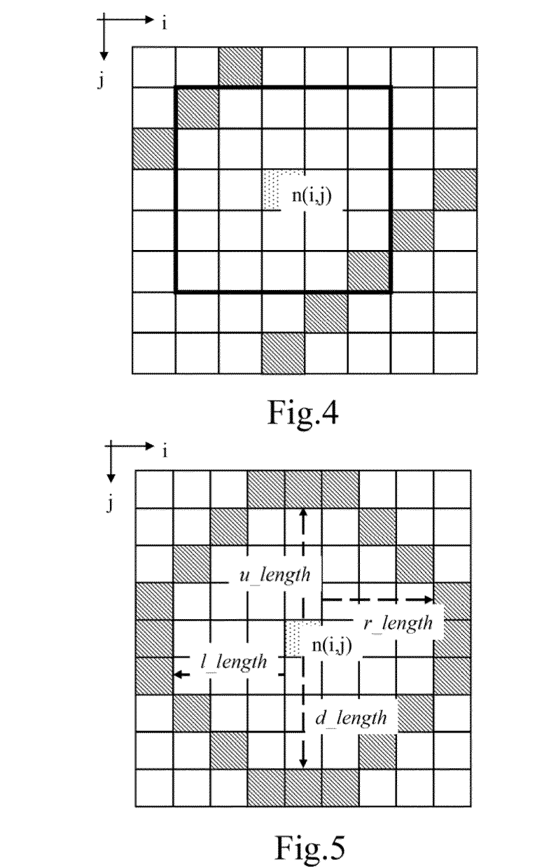

Then, utilize the edge-adaptive algorithm to detect information of two edges, to determine the size of at least a matching block in the left and right maps. Presently, the matching blocks can be classified into fixed blocks and dynamic blocks. The depth information producing by disparity matching algorithm using fixed block size has the following characteristics: the depth map produced by large matching block has less noise, but the shape of the object is less complete; while the shape of an object in a depth map produced by small matching block is more complete, but it has more noise. Therefore, depth information producing by disparity matching algorithm using fixed block size is certain to have one of the shortcomings mentioned above. In the present invention, the dynamic block and edge-adaptive block algorithms are adopted to determine block size through using edge information. As shown in FIG. 4, the dark portions are edges having logic value 1; while the blank portions are non-edge portions having logic value 0. When position n(i, j) is on an edge, use 3×3 small matching block to increase accuracy in the depth non-continuous portion. In case position n(i, j) is not on an edge, then use position n(i, j) as a center to define a square block, as shown as the bold line square block region in FIG. 4, to compute and find out if an edge exist in the square block region. The approach of this computation is to add together the edge logic value of each position in the region, and if its value is not zero, that indicates that an edge is still in the square block region, then reduce size of the square block region. In this embodiment, a square block region of 33×33 is taken as example for explanation, in case the sum of edge logic values in that region is not zero, then reduce length and width of the square block region by a half to 17×17. In this manner, repeat computing sum total and reducing square block region, until no edge exists in the square block region. At this time, the block size is the block size for the position n (i, j).

In determining edge-adaptive block size, firstly, the extension length has to be defined, which can be classified into extension lengths in four directions of up, down, left, and right, indicating movement from present position to extend upward, downward, to the left, or to the right, until it reaches the edge of the object. Then, based on the edge map generated as mentioned above, determine size and shape of a matching block. If the present position is on an edge, then it is extended upward, downward, to the left, and to the right, the width of a pixel, with the purpose of keeping the accuracy in the depth non-continuous portion. In case the position is not on the edge, then search and compute the extension length from this point in upward and downward directions, and then from the extended regions thus obtained, compute the extension length from this point to the right direction and to the left direction. Refer to FIG. 5, it shows the dark portion is edge representing logic 1, and the remaining portions are non-edges representing logic 0. In case the position n (i, j) is on the edge of an object, then its extension length upward, downward, to the left, and to the right are all 1, namely, the size of the block is 3×3. In case the position n (i, j) is outside the edge of an object, then compute the block size to determine if the accumulated value is logic 0, and when the accumulated value is not logic 0, then stop extending the length. Herein, the length extending upward is taken as example for explanation. The accumulated value C_up can be computed according equation (6) as shown below, wherein, n (i, j) is the starting point, it is extended upward distance u_length, with its range 0˜max_length. If the accumulated value is not zero, that means it has reached the edge, thus stopping extending length and accumulating values, and recording the u_length as the upward extension distance. The computation of downward extension length is similar to the computation of upward extension length, it only requires to change extension distance in equation (6) from the negative value u_length to positive value d_length, to indicate the downward extension length. Upon finishing computing upward and downward extension lengths, then compute the extension length to the left and to the right. Herein, the length extending to the left is taken as example for explanation. The accumulated value C_left can be computed according equation (7) as shown below, wherein, n (i, yc) is the starting point, the range of yc is composed of upward and downward extension lengths, then the respective positions in the range yc is moved a distance l_length to the left, with its range of similar 0˜max_length. If the accumulated value is not equal to zero, that means it has reached the edge, thus stopping extending length and accumulating values, and recording the l_length at this time as the extension distance to the left. The computation of extension length to the right is similar to the computation of extension length to the left, it only requires to change extension distance in equation (7) from the negative value l_length to a positive value r_length, to indicate the extension length to the right. Finally, four sets of information u_length, d_length, r_length, l_length are obtained, representing respectively the extension length upward, downward, to the left, and to the right of edge-adaptive block.

$$\begin{matrix}C\_up = {\sum }_{ u\_length = 0}^{max\_length} n ( i , j - u\_length ) , ( i , j ) as the center & ( 6 ) \\ C\_left = {\sum }_{ l\_length = 0}^{max\_length} n ( i - l\_length , y c ) , \\ y c ∈ [ j - u\_length , j + d\_length ] & ( 7 )\end{matrix}$$

Upon determining matching block size for each of the positions, then in step S16 compute Matching Cost, generate preliminary depth maps respectively for the left map and right maps. The following equation (8) is used to compute Matching Cost of fixed block size, bsize is a range of fixed block size. Upon determining the block size, the dynamic block matching algorithm adopts the same approach to compute Matching Cost as that of the fixed block size. The following equation (9) is used to compute the matching cost of edge-adaptive block size. Wherein, L and R represent respectively left and right map information, and subscript c represents YUV three sets of information, dr is matching range. Then, substitute parameters u_length, d_length, r_length, l_length into equation (8) as the range of an arbitrary block size.

$$\begin{matrix}{Cost\_fixed}_{c} = {\sum }_{j = - bsize}^{bsize} {\sum }_{i = - bsize}^{bsize} \vert {L}_{c} ( i , j ) - {R}_{c} ( i - d , j ) \vert , \\ d ∈ [ 0 , dr - 1 ] & ( 8 ) \\ {Cost\_arbi}_{c} = {\sum }_{j = - u\_length}^{d\_length} {\sum }_{i = - l\_length}^{r\_length} \vert {L}_{c} ( i , j ) - {R}_{c} ( i - d , j ) \vert , \\ d ∈ [ 0 , dr - 1 ] & ( 9 )\end{matrix}$$

Upon finishing computing Matching Cost of YUV, allocate the three sets of Matching Costs with appropriate ratio, as shown in the following equation (10). Since human eye is more sensitive to illuminance information Y, than to the color information UV, so allocate YUV with ratio of 2:1:1, to determine the final Matching Cost. The depth value is determined through a Winner Takes All (WTA) strategy, so that each position has a depth value, to form preliminary depth map of left and right maps.

Cost=0.5*Cost_{Y}+0.25*Cost_{U}+0.25*Cost_{V} (10)

Through the computation mentioned above, serious errors still exist in occlusion regions of left and right preliminary depth maps, and that can be corrected by using the mutually complementary characteristics of left and right preliminary depth maps. Therefore, in step S18 of the present embodiment, a cross-check is utilized, to classify the regions in the left and right maps having different depth values into an unreliable depth region; meanwhile, use the statistical information of adjacent pixel depth values to correct the depth value of the unreliable depth region, so as to eliminate the errors in occlusion regions of left and right preliminary depth maps.

The checking of left depth map is taken as an example for explanation, and the conditions for determining unreliable depth regions are as shown in the following equation (11). Suppose d is the depth value of position (i, j) in the left map, and when the difference of depth values between position (i−d, j) of the right map and that of the position (i, j) of left map exceeds an allowable range, then mark the position in the left map having that depth value as in an unreliable depth region. Or in case the difference of depth values is within an allowable range, then keep the depth value of that position.

|L_{depth}(i,j)−R_{depth}(i−d,j)|>offset (11)

After finding out the unreliable depth regions in the left and right maps, perform step S20 to refine the unreliable depth region, to obtain depth map having correct depth values in the left and right maps. In the present invention, the original map is used as a basis for refining the preliminary depth map. Before refining the preliminary depth map, the last four bits of RGB value of the original left and right color maps are replaced with 0, as such the minimum difference of RGB of the respective pixel positions are all 16. Therefore, it is easier to partition range of refined depth map based on the information of color map. The four-bit reduction method used in the present invention is a simple color partition method. In order to obtain better color partition effect, K-means, Mean Shift algorithms can be used.

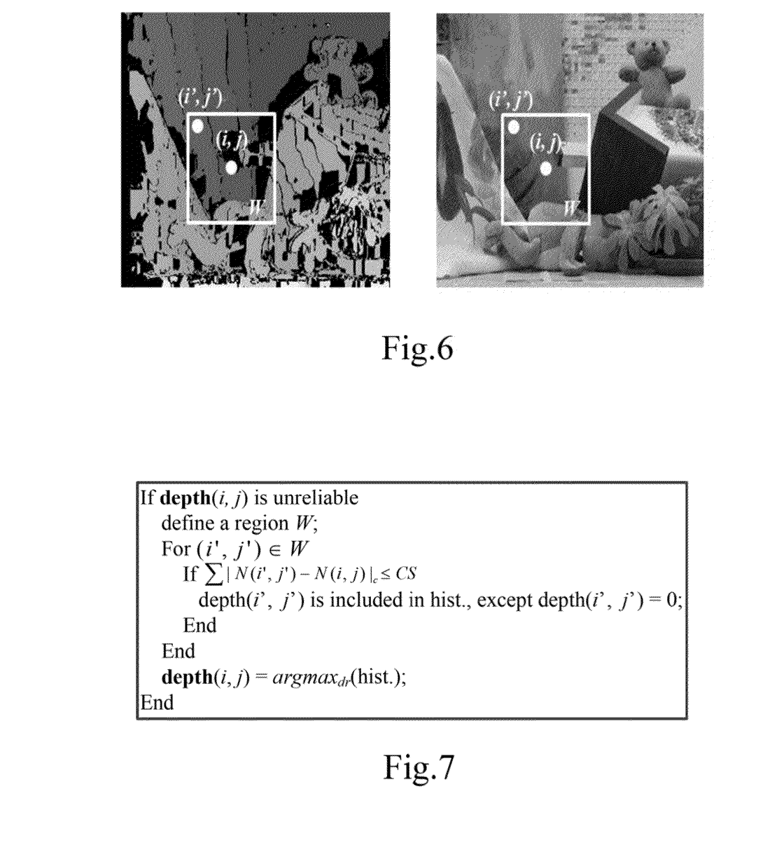

In the following, the refinement of the preliminary depth map of the left map is taken as an example for explanation. As shown in FIG. 6, firstly, input the checked preliminary depth map and the original color map being reduced 4 bits. Next, utilize equation (11) to find the unreliable depth region in the preliminary depth map. Then, define a range W with the position (i, j) as a center, meanwhile define the same range in the color map, and the range is defined as similar color window frame. Subsequently, compare to obtain the difference of RGB pixel value of each position (i′, j′) and that of center position (i, j) in the color map window frame. When the difference is less than a threshold value, record the depth value of that position, and compute number of occurrences of the respective depth values; otherwise, when the difference is not less than a threshold value, then do not record the depth value of that position. The threshold value is defined as color similarity (cs).

Then, record the depth values within the color similarity (cs) in the window frame, plot them into a histogram, and use the histogram to select the refining depth value. In the present invention, the depth value that appears most frequently in the histogram is used to refine the depth values in the unreliable depth region. The algorithm is realized through the pseudo codes as shown in FIG. 7. Wherein, “depth” is the depth map desired to be refined, and the subscript c indicates RGB pixel value.

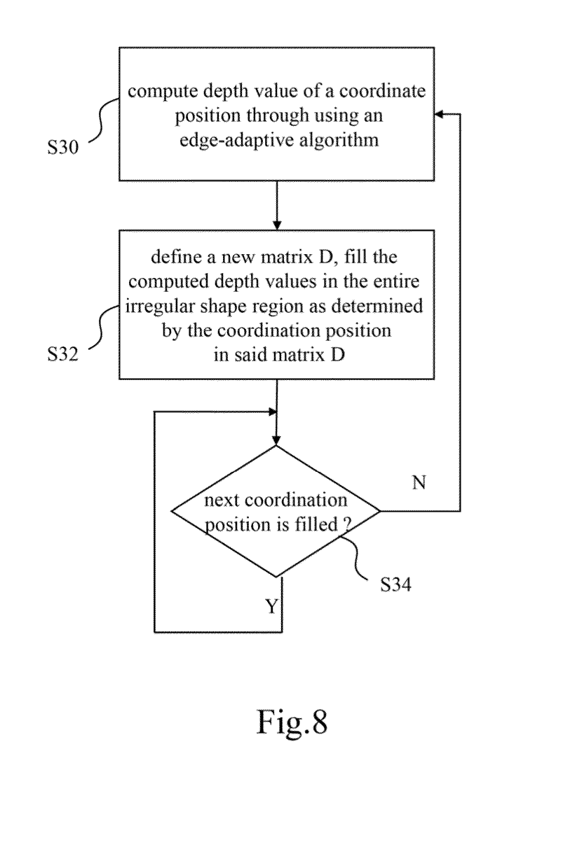

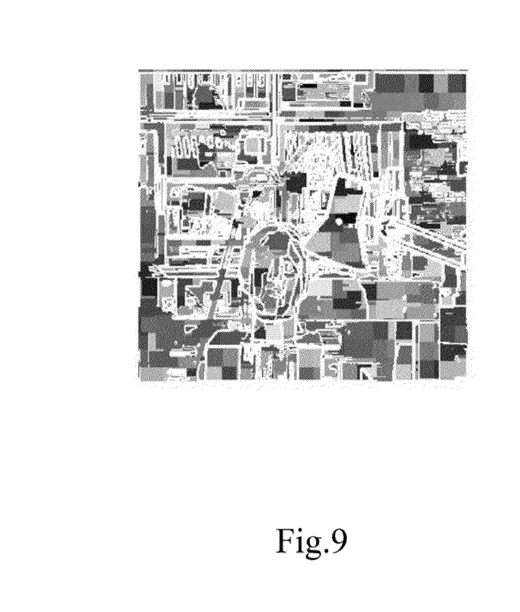

For the matching blocks determined through using the edge-adaptive algorithm, their depth values should be close. The present invention utilizes this characteristic to propose a group-based disparity estimation algorithm to reduce computation time. As shown in FIG. 8, firstly, in step S30, the edge-adaptive algorithm is used to compute the depth value of coordinate position (i, j). Next, in step S32, fill the entire block with the depth value. Then, in step S34, perform downward sampling 2, to determine if the depth value of the next coordinate position (i+2, j) has already computed, if the answer is positive, skip to the next coordinate position (i+4, j) to continue the determination, otherwise, return to step S30, to perform edge-adaptive computation of depth value of a block at position (i+2,j), and repeat the steps mentioned above, until the depth values of positions of the entire map are computed. Since size of the region being filled exceeds a pixel distance, therefore, downward sampling can further be used to reduce the number of times required to determine if the block is filled, hereby reducing further computation time required. In FIG. 9 is shown the size of a block, and each color block indicates block of different size, it also indicates filled depth region. Wherein, white line is edge line, and this portion uses a 3×3 block.

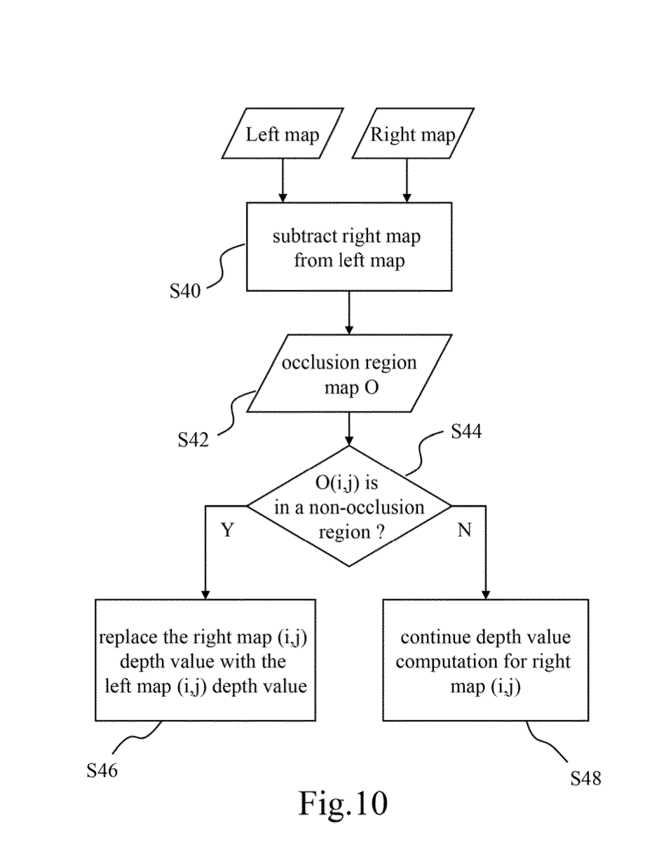

In addition to the group-based disparity estimation algorithm mentioned above, the present invention further provides a left-right depth replacement algorithm. The advantage of this algorithm is that, since the difference between the left and right color maps lies in their differences in the occlusion regions. Therefore, by subtracting the right color map from the left color map, then the occlusion region is left, and that can be used to eliminate the computations required for the non-occlusion region in the left and right maps, thus reducing the time required for computing the left and right maps. The flowchart of the left-right depth replacement algorithm is as shown in FIG. 10, and that is described in an embodiment. Firstly, as shown in steps S40 to S42, subtract the right color map from the left color map to obtain an occlusion region O. Next, in step S44, determine if each position O (i, j) in region O belongs to a non-occlusion region, of which the left map depth value is similar to the right map depth value, in case the answer is positive, then in step S46 replace the depth value of the right map position (i, j) with the depth value of the left map position (i, j), to eliminate the time required to compute the depth value of right map position (i, j); otherwise, perform step S48, to continue computing depth values for the right map position (i, j).

Summing up the above, the present invention provides a disparity estimation depth generation method, which utilizes edge-adaptive matching block search algorithm and unreliable depth region refinement depth generation algorithm, to enhance significantly the accuracy of depth generation. Compared with fixed matching block, the edge-adaptive matching block algorithm may use the shape of the object well to find out the correct disparity value. In addition, with regard to refining depth map, the unreliable depth region refinement algorithm is utilized, to detect the errors of left and right depth maps through cross-check, then utilize the original left and right color map information of reduced bits to refine the errors detected through cross-check, to further reduce error rate of disparity matching. In order to reduce computation time required for disparity estimation, the present invention also provides a group-based disparity estimation algorithm and a left and right depth replacement algorithm, to increase computation speed.

The above detailed description of the preferred embodiment is intended to describe more clearly the characteristics and spirit of the present invention. However, the preferred embodiments disclosed above are not intended to be any restrictions to the scope of the present invention. Conversely, its purpose is to include the various changes and equivalent arrangements which are within the scope of the appended claims.

What is claimed is:

1. A disparity estimation depth generation method, in which after inputting an original left map and original right map in a stereo color image, compute depth of said original left and right maps, comprising following steps:
perform filtering of said original left and right maps, to generate a left map and a right map;
perform edge detection for an object in said left and right maps, to determine size of at least a matching block in said left and right maps, based on information of two edges detected in an edge-adaptive approach;
perform matching cost computation, to generate respectively a preliminary depth map of said left and right maps, and perform cross-check to find out at least an unreliable depth region from said preliminary depth map to perform refinement; and
refine errors of said unreliable depth region.

2. The disparity estimation depth generation method as claimed in claim 1, wherein after inputting said original left and right maps, smooth out noise of said object through low-pass filtering.

3. The disparity estimation depth generation method as claimed in claim 1, wherein enhance contrast of said original left and right maps, so that edges of said original left and right maps are more evident.

4. The disparity estimation depth generation method as claimed in claim 1, further comprising:
after cross-checking said left and right maps, mark said unreliable depth region, and refine depth of said unreliable depth region with depth of similar color region of said original left and right maps.

5. The disparity estimation depth generation method as claimed in claim 1, wherein said unreliable depth region is a depth un-conforming region for said left and right maps.

6. The disparity estimation depth generation method as claimed in claim 1, wherein determining size of block in said left and right maps includes following steps:
define an extension length of said matching block, to determine range extended to edge of said object; and
determine shape and size of said matching block based on a left edge map and a right edge map generated through edge detection.

7. The disparity estimation depth generation method as claimed in claim 1, wherein after determining size of said matching block in said left and right maps, perform computation of said matching cost.

8. The disparity estimation depth generation method as claimed in claim 1, wherein after computing a depth value of a coordination position in said matching block, fill said entire matching block with said depth value by means of said edge-adaptive approach, and also continue to fill block of a next coordination position with depth value through said edge-adaptive approach.

9. The disparity estimation depth generation method as claimed in claim 1, wherein subtract said original right map from said original left map to have at least an occlusion region to produce an occlusion region map, then determine if respective position in said occlusion region map has depth value equal to that of a non-occlusion region of said left and right maps, and if answer is positive, substitute depth value of said position in said left map for depth value of said position in said right map.

10. The disparity estimation depth generation method as claimed in claim 9, wherein in case that depth value of said position in said occlusion region map is not equal to that of said non-occlusion region of said left and right maps, then continue to compute depth value of said position in said right map.
